(19) United States
(12) Patent Application Publication
(10) Pub. No.: US 2009/0144061 A1
(43) Pub. Date: Jun. 4, 2009

(54) Systems and methods for generating verbal feedback messages in head-worn electronic devices

(75) Inventors: Jacob T. Meyberg, Santa Cruz, CA (US); Eric R. Bradford, Campbell, CA (US); Stephen V. Cahill, Felton, CA (US)

Correspondence Address: PLANTRONICS, INC.;IP Department/Legal, 345 ENCINAL STREET, P.O. BOX 635, SANTA CRUZ, CA, 95060-0635, US

(73) Assignee: PLANTRONICS, INC.

(21) Appl. No.: 11/998,183

(22) Filed: Nov. 29, 2007

(51) Int. Cl. G10L 11/00

(52) U.S. Cl. 704/270.1; 704/E13.001

(57) ABSTRACT

Systems and methods for generating and providing verbal feedback messages to wearers of man-machine interface (MMI)-enabled head-worn electronic devices. An exemplary head-worn electronic device includes an MMI and an acoustic signal generator configured to provide verbal acoustic messages to a wearer of the head-worn electronic device in response to the wearer's interaction with the MMI. The head-worn electronic device may be further configured to monitor device states and generate and provide verbal acoustic messages indicative of changes to the device states to the wearer. The verbal messages are digitally stored and accessed by a microprocessor configured to execute a verbal feedback generation program. Further, the verbal messages may be stored according to multiple different natural languages, thereby allowing a user to select a preferred natural language by which the verbal acoustic messages are fed back to the user.

### FIELD OF THE INVENTION

The present invention generally relates to electronic devices having man-machine interfaces (MMIs), and more particularly to systems and methods for generating and providing verbal feedback messages to users of such devices in response to user interaction with the MMIs.

### BACKGROUND OF THE INVENTION

Head-worn electronic devices, such as headsets, are used in a variety of applications, including listening to music and communications. Modern head-worn electronic devices are versatile and often offer various functions. For example, some state-of-the-art Bluetooth enabled headsets provide users the ability to both listen to music (e.g., from a Bluetooth-enabled MP3 player) and to engage in hands-free communications with others (e.g., by using a Bluetooth-connected cellular telephone).

A typical, modern head-worn electronic device includes a variety of switches, buttons and other controls (e.g., mute on/off, volume up/down, track forward/back, channel up/down controls), which allow the user to control the device's operation. These switches, buttons and other controls are collectively referred to in the art as a man-machine interface, or “MMI.”

One problem related to head-worn electronic devices equipped with MMIs is that the user cannot see the MMI when the device is being worn. This makes interacting with the MMI difficult and cumbersome. In an attempt to avoid this problem, some prior art approaches provide tactile feedback information in the form of audible beeps or tones that are presented to the user in response to a command applied to the MMI. The beeps or tones are used to convey various messages to the user. For example, depending on the type of device and interaction involved, the beeps or tones are used to convey an acknowledgement to the user that a command has been received and accepted by the device, an acknowledgement to the user that a command has been received but rejected by the device, or used merely to provide tactile feedback to the user that a certain control of the MMI is currently being manipulated.

Unfortunately, using beeps or tones can be confusing to users. In fact, it is not uncommon for a user to confuse one MMI feedback signal with another, particularly when the beeps or tones of different MMI feedback responses are not easily distinguishable. This confusion can lead to uncertainty as to whether a commanded function or operation has been performed properly, or has even been performed at all. The level of confusion is compounded for untrained users, to which the beeps or tones may have no meaning whatsoever.

Prior art approaches also use beeps or tones in an attempt to provide users with information relating to various monitored device states. For example, beeps or tones may be used to inform the user that the device's battery is low or the device is out of range of an access point, base station or Bluetooth coupled device. Unfortunately, similar to the problems resulting from using beeps or tones for MMI feedback, using beeps or tones to report device state information can be confusing to users.

Given the foregoing drawbacks, problems and limitations of the prior art, it would be desirable to have systems and methods that generate and provide unambiguous and easily ascertainable MMI feedback and device state information to users of head-worn electronic devices.

### BRIEF SUMMARY OF THE INVENTION

Systems and methods for generating and providing verbal feedback messages and device state information to users of MMI-enabled head-worn electronic devices are disclosed. An exemplary head-worn electronic device includes an MMI and an acoustic verbal message generator that is configured to provide verbal acoustic messages to a wearer of the head-worn electronic device, in response to the wearer's interaction with the MMI. Since the verbal messages are provided verbally, the confusion resulting from use of beeps or tones used in prior art approaches is avoided.

In accordance with one aspect of the invention, a head-worn electronic device includes one or more detectors or sensors coupled to a microprocessor-based subsystem. The one or more detectors or sensors are configured to detect or sense event signals corresponding to monitored device states and/or commands applied to the MMI by the device user. The detected event signals are used by the microprocessor-based subsystem to generate and provide the verbal feedback and/or device state information to the user.

In accordance with another aspect of the invention, the microprocessor-based subsystem includes a memory device configured to store a plurality of verbal messages corresponding to the various MMI commands and/or information relating to the monitored device states. The verbal messages may be stored in more than one natural language (e.g., English, Chinese, French, Spanish, Korean, Japanese, etc.) with a first set of verbal messages stored according to a first natural language, a second set of verbal messages stored according to a second natural language, etc. The language of choice can be selected by a user during an initialization of the device and can be reset in a reconfiguration process. Although not required, the various sets of verbal messages in different languages can be configured to share the same data structure or memory space, so that access to a particular message entry can be conveniently accessed, irrespective of the language choice selection.

Further features and advantages of the present invention, as well as the structure and operation of the above-summarized and other exemplary embodiments of the invention, are described in detail below with respect to accompanying drawings in which like reference numbers are used to indicate identical or functionally similar elements.

### BRIEF DESCRIPTION OF THE DRAWINGS

FIG. 1 is a diagram showing an environment in which head-worn electronic devices may be deployed to generate and provide verbal feedback and device state information to a user of the device;

FIG. 2 is a diagram illustrating an exemplary man-machine interface (MMI) that may be used in any one of the various head-worn electronic devices described herein;

FIG. 3A is a schematic diagram illustrating salient components of an exemplary head-worn electronic device, according to an embodiment of the present invention;

FIG. 3B is a schematic diagram illustrating salient components of an exemplary head-worn electronic device, according to another embodiment of the present invention;

FIG. 3C is a schematic diagram illustrating salient components of an exemplary head-worn electronic device, according to yet another embodiment of the present invention; and

FIG. 4 is a flowchart illustrating a process by which a head-worn electronic device is operable to generate and provide verbal feedback and device state information to a user in response to MMI commands and detected changes to device states, according to an embodiment of the present invention.

### DETAILED DESCRIPTION

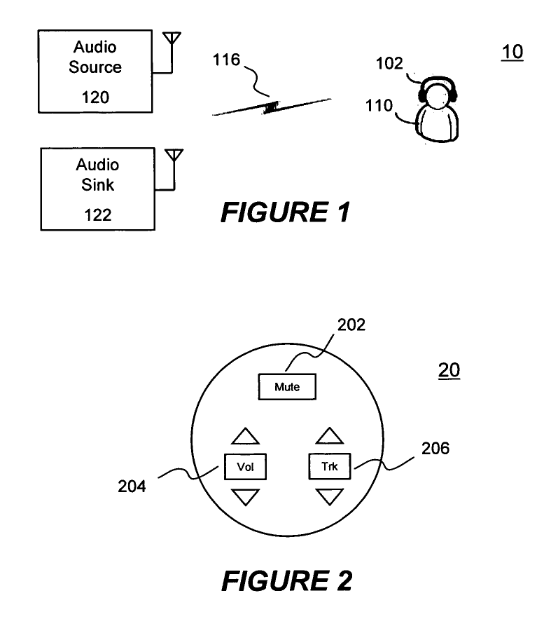

Referring to FIG. 1, there is shown an environment 10 in which a head-worn electronic device 102 having an MMI may be deployed to generate and provide verbal feedback and device state information to a user (i.e., “wearer”) 110 of the device 102. The verbal feedback and device state information comprise verbal messages that are digitally stored in a memory device configured within the head-worn electronic device. As explained in more detail below, in response to a command applied to an MMI of the electronic device, or in response to a change in state of the device, an appropriate corresponding verbal message is retrieved from the memory device and converted to a verbal acoustic message that is verbalized to the device user.

The head-worn electronic device 102 may comprise, for example, music headphones, a communications headset, or a head-worn cellular telephone. While the term “headset” has various definitions and connotations, for the purposes of this disclosure, the term is meant to refer to either a single headphone (i.e., a monaural headset) or a pair of headphones (i.e., binaural headset), which include(s) or does not include, depending on the application and/or user-preference, a microphone that enables two-way communication.

The head-worn electronic device 102 is configured to receive audio data signals (e.g., voice data signals) from an audio source 120 and/or transmit audio data signals to an audio sink 122, via a wireless link 116. The audio data signals can be encoded and/or compressed, similar to the verbal feedback messages described below. The audio source 120 may comprise any device that is capable of transmitting wired or wireless signals containing audio information to the head-worn electronic device 102. Similarly, the audio sink 122 may comprise any device that is capable of receiving wired or wireless signals containing audio information from the head-worn electronic device 102. The wireless link 116 may comprise a Digital Enhanced Cordless Telecommunications (DECT) link, a DECT 6.0 link, a Bluetooth wireless link, a Wi-Fi (IEEE 802.11) wireless link, a Wi-Max (IEEE 802.16) link, a cellular communications wireless link, or other wireless communications link (e.g., infra-red, ultrasonic, magnetic-induction-based, etc.). While a wireless head-worn device is shown as being coupled to the audio source 120 and audio sink 122 via a wireless link 116, a wired head-worn device may alternatively be used, in which case electrical wires would be connected between the head-worn electronic device 102 and the audio source 120 and audio sink 122.

The head-worn electronic device 102 also includes an MMI comprised of switches, buttons and/or other controls. FIG. 2 shows one example of an MMI 20 that includes a mute toggle button 202, volume up/down controls 204, and track forward/back controls 206. The various controls of the MMI 20 are manipulated by a wearer of the head-worn electronic device 102, to control the function and/or operation of the head-worn electronic device 102. For example, the wearer 110 pushes or presses the mute toggle button 202 to mute currently playing acoustic signals in the headset so that the wearer 110 can direct their attention to other activities (e.g., having a conversation with another person). Those of ordinary skill in the art will readily appreciate and understand that, depending on the application, the MMI 20 may include additional controls or have different controls than what are shown in the drawing.

According to an aspect of the invention, verbalized feedback information (e.g., a verbal acknowledgment message, verbal prompt, a verbal message indicating the wearer's interaction with the MMI, etc.) is fed back to the user in response to the user's interaction with the controls of the MMI. According to another aspect of the invention, verbal messages informing of a change in device state are provided to the user. Changes in device states may include, for example, low battery, out-of-range of an audio source or audio sink, wireless link signal strength low, etc. The device states are detected and monitored by one or more detectors or sensors.

According to another aspect of the invention, the head-worn electronic device 102 includes a verbal message generation program module and an associated microprocessor-based (or microcontroller-based) subsystem comprising a microprocessor (e.g., an application specific integrated circuit (ASIC), a field-programmable gate array (FPGA), or system on a chip (SoC)) and a memory device (e.g., an erasable programmable read only memory (EPROM), an electrically erasable programmable read only memory (EEPROM), a read only memory (ROM), or a random access memory (RAM)). As explained in more detail below, the microprocessor is configured to execute instructions provided by the verbal message generation program to generate verbal feedback messages in response to MMI commands entered by the user and/or to provide verbal device state information messages reporting changes in monitored device states.

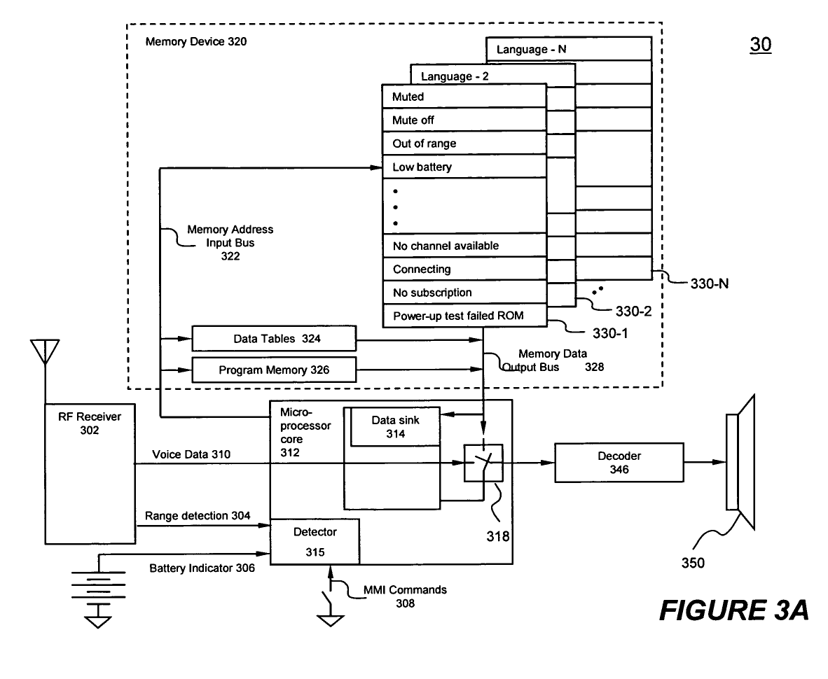

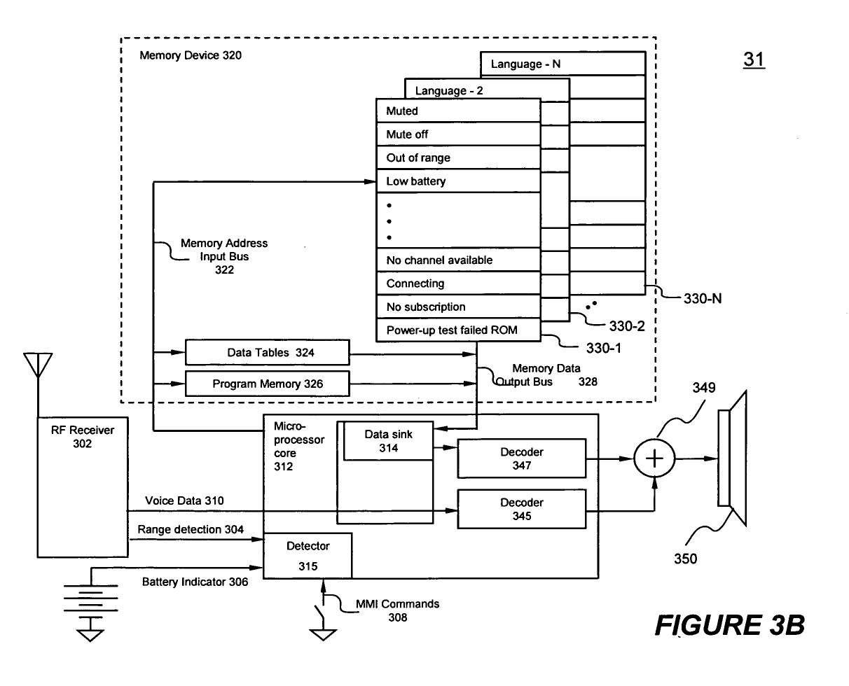

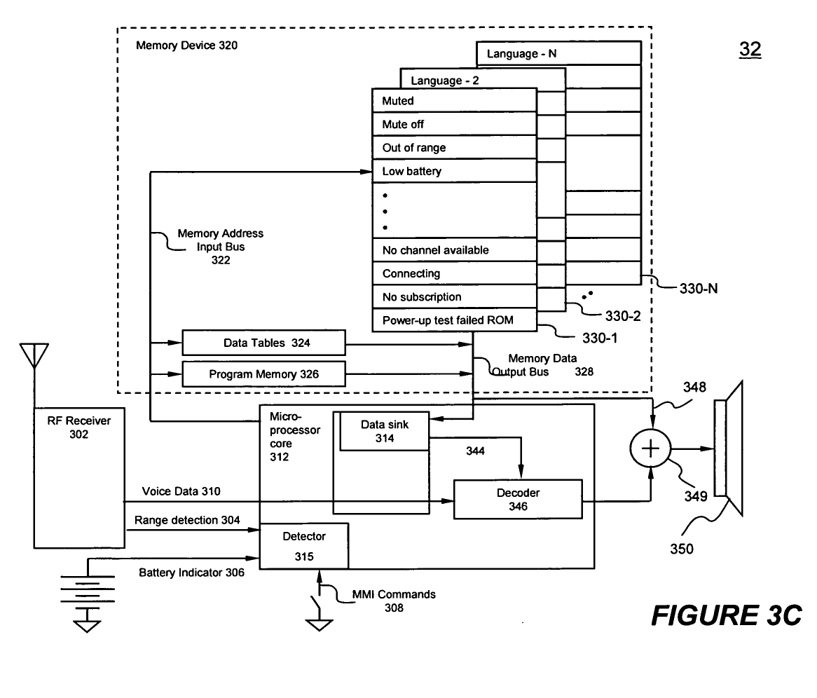

FIG. 3A is a schematic drawing of a head-worn electronic device, e.g., a headset 30, which is configured to generate and provide verbal feedback information to a user of the headset 30, in response to MMI commands and/or changes in device states, according to an embodiment of the present invention. The headset 30 comprises a radio frequency (RF) receiver 302 (or transceiver), a microprocessor core 312, a memory device 320, one or more detectors or sensors 315, a decoder 346 (e.g., an Adaptive Differential or Delta Pulse-Code Modulation (ADPCM) decoder or a Continuous Variable Slope Delta Modulation (CVSD) decoder), and an acoustic transducer 350 (e.g., a speaker).

The wireless receiver 302 is configured to receive audio data signals from an audio source 120 over a wireless link 116. The modulated RF signals are demodulated and directed to the decoder 346 via the microprocessor core 312. The decoder 346 decodes and/or decompresses the received audio data signals 310 into audio signals, which are provided to the acoustic transducer 350 to generate verbal acoustic messages for the user.

The memory device 320 of the microprocessor-based subsystem is coupled to the microprocessor core 312 via a memory I/O bus (e.g., memory address input bus 322 and memory data output bus 328). It is configured to provide memory space for data tables 324, program memory 326 for the verbal message generation program module, and the verbal messages. While only a single memory device 320 is shown as providing these functions, a plurality of memory devices can alternatively be used. Further, the verbal messages may be encoded and/or compressed before storing in the memory device 320. Any number of encoding and/or compression schemes can be used. For example, an ADPCM decoder or a CVSD may be used, as shown in FIG. 3A. In order to make most efficient use of available storage space in the memory device 320, the stored verbal messages may be encoded using the same encoding scheme (e.g., ADPCM or CVSD) as is used to encode the received audio data signals.

The plurality of verbal messages may be configured as a verbal message data table 330-1 in the memory device 320, as illustrated in FIG. 3A. Each entry of the data table 330-1 corresponds to an MMI command or monitored device state. The messages may be pre-recorded with human voice (e.g., using a professional recording service) or may be computer generated.

The detectors or sensors 315 are configured to detect and receive event signals produced by MMI commands 308 entered by the user, as well as changes to monitored device states. The microprocessor core 312 is configured to receive the event signals, and by the direction of the verbal message generation program, is operable to determine, access and retrieve the appropriate verbal messages stored in the verbal message data table 330-1 corresponding to the detected event signals. The retrieved verbal messages are decoded by the decoder 346 (if necessary) and directed to the acoustic transducer 350, which generates verbal acoustic messages for the user to hear.

According to one aspect of the invention, the verbal messages are stored in multiple different languages (e.g., English, Chinese, Spanish, French, German, Korean, Japanese, etc.), as indicated by the additional verbal message data tables 330-2, . . . , 330-N (where N is an integer greater than or equal to one) in FIG. 3A. This provides a user the ability to select a preferred language for receiving the acoustic verbal messages. All of the verbal message data tables 330-1, 330-2, . . . ,330-N can be configured to share the same addressing structure, so that access to a particular verbal message entry is similar. For example, the order of the entries is the same in all of the data tables 330-1, 330-2, . . . , 330-N.

A data sink 314 and an audio data switch 318 are also included in the headset 30 in FIG. 3A. The data sink 314 and audio data switch 318 determine how the verbal messages and audio data signals 310 are to be verbalized to the user. According to this embodiment of the invention, the audio data switch 318 is configured to allow only one data path to be connected to the decoder 346 and the acoustic transducer 350 at any one time. During normal operation a data path for directing audio data signals 310 received by the receiver 302 to the decoder 346 and acoustic transducer 350 is provided. When an event signal is detected, the audio data switch 318 blocks the audio data signals 310, and an appropriate verbal message from the verbal message data table 330-1 is directed to the decoder 346. So, for example, when a “low battery” event is detected while the user is listening to an audio program, the user will hear only the verbal message “low battery” without any interference from voices or sounds contained in the audio data signals 310. In other words, the verbal messages and the received audio data signals are played back exclusively according to this embodiment of the invention.

Referring now to FIG. 3B, there is shown a schematic drawing of a head-worn electronic device, e.g. a headset 31, which is configured to generate and provide verbal feedback information to a user of the headset 31, in response to MMI commands and/or changes in device states, according to another embodiment of the present invention. Most of the components of this headset 31 are the same or similar to those of the headset 30 in FIG. 3A. However, the headset 31 in FIG. 3B includes two decoders 345 and 347, instead of just one 346. Additionally, an audio summer 349 is included. The decoder 345 is configured to decode and/or decompress the received audio data signals and then to direct the decoded audio data signals to the audio summer 349. The decoder 347 is configured to decode and/or decompress the retrieved verbal messages from the data sink 314 and then direct the decoded verbal messages to the audio summer 349. The audio summer 349 operates to combine the decoded audio data signals from the decoders 345 and 347 before sending them both to the acoustic transducer or speaker 350 for the user to listen to. Hence, according to this embodiment of the invention, the user hears both the audio in the received audio data signals and the retrieved verbal message at the same time.

FIG. 3C is a schematic drawing of a head-worn electronic device, e.g. a headset 32, which is configured to generate and provide verbal feedback information to a user of the headset 32, in response to MMI commands and/or changes in device states, according to another embodiment of the present invention. Most of the components of the headset 32 in FIG. 3C are the same or similar to the components of the headsets 30 and 31 in FIGS. 3A and 3B. The headset 32 includes one decoder 346 and one audio summer 348. The decoder 346 is configured to decode or decompress the received audio data signals 310, and then direct the resulting decoded audio data signals to the summer 349. The verbal messages may or may not be encoded. When the verbal messages are encoded, the decoder 346 is also configured to decode or decompress the verbal messages retrieved from the data sink 314 via signal line 344. When the verbal messages are not encoded, the retrieved verbal messages are directed to the summer 349 via signal line 348. The summer 349 combines the decoded audio signals from decoder 346 and retrieved messages before sending them to the acoustic transducer or speaker 350.

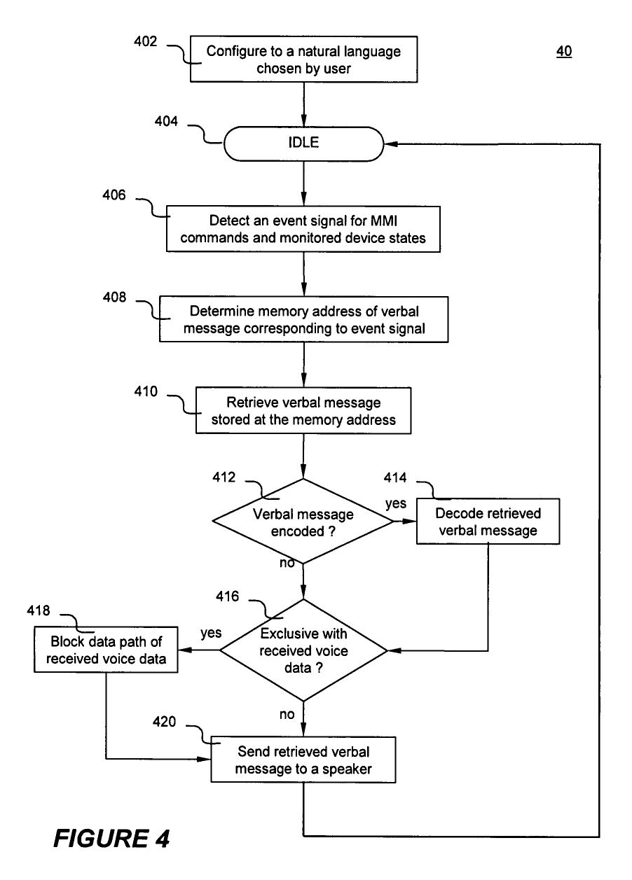

FIG. 4 is a flowchart illustrating a process 40 by which a head-worn electronic device is operable to generate and provide verbal feedback and device state information to a user in response to MMI commands and changes in device states, according to an embodiment of the present invention. The process 40 is preferably understood in conjunction with the previous figures.

A first step 402 in the process 40 involves an initialization procedure in which the user 110 selects a natural language, from a plurality of available natural languages, to be used to verbalize the verbal messages. After the initialization step 402 is completed, the process 40 holds in an idle state 404, in wait for an event signal for generating verbal messages.

Once an event signal is received at step 406, indicating an MMI command or change in device state, the verbal message generation process commences. Triggering of an event signal can occur automatically according to a predetermined update schedule, manually (e.g., by the user 110), by detected MMI commands entered by the user 110 (e.g., mute, mute off, volume up/down), or by a detected change in a monitored device state of the headset 102 (e.g., headset 102 coming within range or going out-of-range of the audio source 120 or audio sink 122, low battery, etc.).

In response to a detected event signal in step 406, at step 408 the memory address of the appropriate verbal message stored in the verbal message data table is determined. Once the unique memory address is determined, at step 410 the verbal message is accessed and retrieved. Next, at decision 412 it is determined whether the retrieved verbal message is in an encoded data format. If “yes”, at step 414 the retrieved verbal message is decoded and/or decompressed accordingly. The process 40 then moves to another decision 416 after step 414. If “no” at decision 412, the process 40 goes directly to the decision 416 without any decoding or decompressing process.

At decision 416, the verbal message playback mode is checked to determine whether the verbal messages are to be played back exclusively with the audio data signals received from the audio source 120. If “yes”, at 'step 418 the receive path for directing the received audio data signals to the acoustic transducer or speaker 350 is temporarily disabled or blocked, and the process 40 moves to step 420. If “no”, the process 40 moves directly to step 420, in which the retrieved verbal message corresponding to the detected event signal is converted to an verbal acoustic message that is verbalized by an acoustic transducer 350 (e.g., a speaker) to the user 110. Finally, the process 40 returns to the idle state 404, in wait for a subsequent event signal.

Although the present invention has been described with reference to specific embodiments thereof, these embodiments are merely illustrative, and not restrictive of, the present invention. Various modifications or changes to the specifically disclosed exemplary embodiments will be suggested to persons skilled in the art. For example, whereas the head-worn electronic device has been shown and described as a headset comprising a binaural headphone having a headset top that fits over a user's head, other headset types including, without limitation, monaural, earbud-type, canal-phone type, etc. may also be used. Depending on the application, the various types of headsets may include or not include a microphone for providing two-way communications. Moreover, while some of the exemplary embodiments have been described in the context of a headset, those of ordinary skill in the art will readily appreciate and understand that the methods, system and apparatus of the invention may be adapted or modified to work with other types of head-worn electronic devices. In summary, the scope of the invention should not be restricted to the specific exemplary embodiments disclosed herein, and all modifications that are readily suggested to those of ordinary skill in the art should be included within the spirit and purview of this application and scope of the appended claims.

What is claimed is:

1. A head-worn electronic device, comprising:
a man-machine interface (MMI) having a plurality of controls; and
an acoustic signal generator configured to provide verbal acoustic feedback messages to a wearer of the head-worn electronic device, in response to the wearer's interaction with the MMI.

2. The head-worn electronic device of claim 1, further comprising:
a microprocessor-based subsystem configured to execute instructions provided by a verbal message generation program; and
a memory device configured to store a plurality of verbal messages.

3. The head-worn electronic device of claim 2 wherein said microprocessor-based subsystem and verbal message generation program are configured to select a message from the plurality of verbal messages stored in said memory device, based on which control of said MMI the wearer interacts with, and provide the selected verbal message to the acoustic signal generator to generate and provide a verbal acoustic feedback message to the wearer.

4. The head-worn electronic device of claim 2 wherein said microprocessor-based subsystem and verbal message generation program are configured to select a verbal message from the plurality of messages stored in said memory device, based on how the wearer interacts with the MMI, and provide the selected verbal message to the acoustic signal generator to generate and provide a verbal acoustic feedback message to the wearer.

5. The head-worn electronic device of claim 2 wherein the memory device is configured to store a plurality of verbal state information messages, and said microprocessor-based subsystem and verbal message generation program are configured to select a verbal state information message from the plurality of verbal state information messages, based on a detected change in state of the head-worn electronic device.

6. The head-worn electronic device of claim 5 wherein said acoustic signal generator is further configured to generate and provide a verbal acoustic state information message to the wearer using the verbal state information message selected from said memory device.

7. The head-worn electronic device of claim 2 wherein the plurality of verbal messages stored in said memory device comprises a plurality of verbal messages stored according to multiple different natural languages.

8. The head-worn electronic device of claim 7 wherein the acoustic signal generator is configured to provide verbal acoustic messages in a natural language selected by the wearer.

9. The head-worn electronic device of claim 2 wherein the verbal messages comprise encoded verbal messages, and the head-worn electronic device includes one or more decoders configured to decode the encoded verbal messages.

10. The head-worn electronic device of claim 9 wherein said one or more decoders is or are further configured to decode encoded audio data signals received from an external audio data source.

11. The head-worn electronic device of claim 10 wherein said encoded verbal messages and said encoded audio data signals are encoded using the same encoding scheme.

12. The head-worn electronic device of claim 9 wherein said one or more decoders comprises an Adaptive Differential Pulse Code Modulation (ADPCM) decoder.

13. The head-worn electronic device of claim 9 wherein said one or more decoders comprises a Continuous Variable Slope Delta Modulation (CVSD) decoder.

14. The subject matter claimed in claim 1 wherein the head-worn electronic device comprises one or more headphones.

15. The subject matter claimed in claim 1 wherein the head-worn electronic device comprises a communications headset.

16. The subject matter claimed in claim 1 wherein the head-worn electronic device comprises a cellular telephone.

17. A method of generating verbal acoustic feedback messages in a head-worn electronic device, comprising:
receiving a command applied to a man-machine interface (MMI) of a head-worn electronic device; and
generating a verbal acoustic feedback message in response to the command applied to the MMI.

18. The method of claim 17, further comprising storing a plurality of verbal messages corresponding to a plurality of commands that can be applied to said MMI in a memory device.

19. The method of claim 18 wherein generating the verbal acoustic feedback message comprises retrieving a verbal message from said plurality of verbal messages stored in said memory device, based on a command applied to the MMI.

20. The method of claim 17, further comprising generating a verbal acoustic state information signal, in response to a change in state of the head-worn electronic device.

21. The method of claim 17 wherein generating the verbal acoustic feedback message comprises generating the verbal acoustic feedback message in a natural language specified by a user of the head-worn electronic device.

22. A head-worn electronic device, comprising:
means for controlling functions or operations of a head-worn electronic device; and
means for providing verbal feedback messages to a wearer of the head-worn electronic device in response to the wearer's interaction with said means for controlling.

23. The head-worn electronic device of claim 22, further comprising means for storing a plurality of verbal messages.

24. The head-worn electronic device of claim 23 wherein said means for providing verbal feedback messages includes a microprocessor configured to access and retrieve a verbal message from said plurality of verbal messages, based on how the wearer interacts with said means for controlling.

25. The head-worn electronic device of claim 23 wherein said means for providing verbal feedback messages comprises a microprocessor configured to access and retrieve a verbal message from said plurality of verbal messages, said retrieved verbal message relating to which control of a plurality of controls of said means for controlling the wearer interacts with.

26. The head-worn electronic device of claim 23 wherein said means for storing a plurality of verbal messages includes means for storing a plurality of verbal messages in multiple different natural languages.

27. The head-worn electronic device of claim 22 wherein said means for providing verbal feedback messages to a wearer of the head-worn electronic device includes means for providing verbal information relating to a monitored operational state of the head-worn electronic device.

28. The subject matter claimed in claim 22 wherein the head-worn electronic device comprises one or more headphones.

29. The subject matter claimed in claim 22 wherein the head-worn electronic device comprises a communications headset.

30. The subject matter claimed in claim 22 wherein the head-worn electronic device comprises a cellular telephone.
